(19) United States
(12) Patent Application Publication
(10) Pub. No.: US 2008/0199592 A1
(43) Pub. Date: Aug. 21, 2008

(54) FLUIDIZED-BED GRANULATES THAT HAVE A HIGH PROPORTION OF FRUIT

(75) Inventors: Wolfgang Fexer, Holzminden (DE); Eric Gruber, Holzminden (DE)

Correspondence Address: CONNOLLY BOVE LODGE & HUTZ, LLP, P O BOX 2207, WILMINGTON, DE, 19899, US

(73) Assignee: SYMRISE GmbH & Co. KG, Holzminden (DE)

(21) Appl. No.: 12/028,204

(22) Filed: Feb. 8, 2008

Related U.S. Application Data
(60) Provisional application No. 60/888,976, filed on Feb. 9, 2007.

(51) Int. Cl. A23L 1/222; A23L 1/48

(52) U.S. Cl. 426/638; 426/650; 426/531

(57) ABSTRACT

The present invention concerns flavoring granulates that can be manufactured by means of a fluidized-bed process, wherein the flavoring granulates have a substantially spherical geometry with solid spherical bodies comprising or consisting of the following components, in each case relating to the flavoring granulate obtained:
aa) 60% to 90% by weight of a dry fruit substance
and
bb) a carrier matrix comprising or consisting of
   ) 10% to 40% by weight of a magnesium salt of one or more solid, edible acids
or
   ii) a mixture of
   a. 5% to 20% by weight of magnesium hydroxide and
   b. 5% to 20% by weight of one or more solid, edible acids,
      uses of the flavoring granulates according to the present invention as well as a fluidized-bed process.

### RELATED APPLICATIONS

This application claims benefit of U.S. Provisional application 60/888,976, filed Feb. 9, 2007.

The present invention concerns flavoring granulates manufactured by means of a fluidized-bed process, which have a dry matter proportion of fruit of 60% to 90% by weight (anhydrous mass of fruit) and a special carrier matrix, a process for the manufacture of such flavoring granulates, products suitable for consumption containing such flavoring granulates and uses of such flavoring granulates as well as a fluidized-bed process per se.

The continuously rising demand for products in the food and drink sector also increases the demand for constantly new flavors. It should be noted that in particular the demand for natural flavoring substances is growing because more and more consumers would like to eat in a health-conscious way and pay particular attention to natural products. On the other hand, some countries, especially in the European Union or the United States of America, have legal requirements for attaching descriptive labels or for identifying the fruits contained, according to which, for example, only products may be marketed that comprise natural flavors, with images on the labels of the packaging of the base products used such as, for example, an image of a strawberry. In contrast to this, mere drawings can indicate the base fruit on labels of products with flavors identical to nature or synthetic flavors.

Natural flavoring substances are basically divided into three main groups:

“From-The-Named-Fruit” (FTNF) flavoring substances consist of extracts or distillates of the respective, named foodstuff. It is already apparent from this description that the origin of these flavoring substances is, namely, that they are solely derived from the respective, named fruit. Generally, the flavoring substances in FTNF present authentic and natural aroma and flavor characteristics.

“With-Other-Natural-Flavorings” (WONF) represent FTNF flavoring substances that are mixed with other natural flavoring substances.

Natural flavoring substances comprise flavoring substances of any origin so long as their origin is natural. They do not, therefore, have to come from the named fruit.

Because of the health-conscious behavior of consumers together with the respective labeling requirements, there is a demand for the production of FTNF flavoring substances.

The U.S. Pat. No. 4,664,920 discloses a powder having a high fruit content, that contains a carrier matrix based on magnesium salts with certain acids. This powder is manufactured by means of freeze drying, spray drying or drum drying. In Example 1, a powder is manufactured by means of spray drying that contains 85% by weight of juice solids and 15% by weight of magnesium citrate carrier. Example 3 describes the manufacture of a powder by means of spray drying, that contains 70% by weight of tomato solids and 30% by weight of magnesium citrate carrier.

The disadvantage of this process is that the powders manufactured by means of spray drying represent spherical particles that have hollow bodies due to the manufacturing process. Consequently, the overall volume of the powder particles does not comprise flavoring material.

A further disadvantage of the process described in the U.S. Pat. No. 4,664,920 is that in the respective spray procedure which contains the magnesium cation, the acidic anion and the components that are to be attached can be mixed together just shortly before the drying procedure and must then be passed directly to the spray drying procedure (cf. column 2, lines 43 to 49 in the U.S. Pat. No. 4,664,920).

Furthermore, spray drying processes lead to the production of medium-sized powder particles that are smaller than 120 μm. By using this kind of powder, for example in mixtures of tea-leaves, it can therefore frequently lead to de-mixing of the powder and tea components. The manufacture of powders by means of spray drying also leads to the production of a wide particle size distribution so that the powders produced have to be sieved and, apart from the time consumed, this means that valuable material becomes lost.

Granulates can be manufactured by a fluidized-bed process which provides a narrow particle size distribution as well as an adjustable particle size, so that the size can be adjusted in such a way as to reduce its de-mixing from the product to be mixed.

However, fluidized-bed processes, as these are already known in the prior art, generally can only achieve dry matter fruit contents (the percentage of fruit dry matter in the total weight of granulate) of less than 50% by weight, especially between 10% to 40% by weight. With a fruit dry matter content in excess of 50% by weight, together with the usual carrier materials, gum Arabic and/or maltodextrin, breakdown and/or clumping of the content of the fluidized-bed regularly occurs. This behavior increases as the proportion of fruit dry matter content increases. The resulting products contain increasing proportions of, amongst other things, spongy or coralline structures (up to 15 cm in diameter in the pilot plant).

As a result, there is still a considerable demand for the manufacture of FTNF flavoring substances, in which the dry matter content of fruit in relation to the overall weight of the granulate, is higher compared to the prior art and these granulates can be produced in such a size that, depending on the products with which it is to be mixed, de-mixing is reduced and color-stable granulates are form during manufacture, i.e. undesirable color changes of the granulates are not obtained.

The invention is resolved by a fluidized-bed process for the manufacture of flavoring granulates, wherein the process comprises the following stages or consists thereof:

A) Preparation of a solution, emulsion or suspension comprising or consisting of
a) optionally one or more solvents
and
b) a mixture comprising or consisting of
aa) fruit juice and/or fruit juice concentrate
and
bb) a carrier matrix comprising or consisting of
   i) a magnesium salt of one or more solid, edible acids
   or
   ii) a mixture of
      a. magnesium hydroxide and
      b. one or more solid, edible acids,
         B) Spraying the solution, emulsion or suspension from A) into a fluidized-bed granulator, and
         C) Separation of the flavoring granulates obtained, which substantially have a spherical geometry with solid spherical bodies, comprising or consisting of the following components, in each case relating to the overall weight of the flavoring granulates obtained:
aa) 60% to 90% by weight of dry fruit substance
and
bb) a carrier matrix comprising or consisting of
   i) 10% to 40% by weight of a magnesium salt of one or more solid, edible acids
   or
   ii) a mixture of
      a. 5% to 20% of magnesium hydroxide and
      b. 5% to 20% of one or more solid, edible salts.

A further embodiment of the present invention concerns flavoring granulates that can be manufactured according to the process according to the present invention as described above, wherein the flavoring granulates have a substantially spherical geometry with a solid spherical body and comprise or consist of the following components in each case relating to the overall weight of the flavoring granulates produced:
aa) 60% to 90% by weight of dry fruit substance
and
bb) a carrier matrix comprising or consisting of
   i) 10% to 40% by weight of a magnesium salt of one or more solid, edible acids
or
   ii) a mixture of
      a. 5% to 20% by weight of magnesium hydroxide and
      b. 5% to 20% by weight of one or more solid, edible acids

A further embodiment of the present invention concerns products that are suitable for consumption, containing flavoring granulates that can be produced according to a process according to the present invention, wherein the flavoring granulates comprise or consist of the following components, in each case relating to the overall weight of the flavoring granulates produced:
aa) 60% to 90% by weight of dry fruit substance
and
bb) a carrier matrix comprising or consisting of
   i) 10% to 40% by weight of a magnesium salt of one or more solid, edible acids
or
   ii) a mixture of
      a. 5% to 20% by weight of magnesium hydroxide and
      b. 5% to 20% by weight of one or more solid, edible acids.

A further embodiment of the present invention concerns the use of flavoring granulates, according to the present invention, in foodstuffs, luxury foods and semi-finished products and for the manufacture of foodstuffs, luxury foods and semi-finished products.

The preferred embodiments of the present invention are, in particular, those described in the dependent claims. The preferred embodiments of the abovementioned embodiments of the present invention can be partly or completely combined with one another, even if the description makes no specific references thereto.

According to the present invention, the preferred flavoring granulates comprise or consist of the following components, in each case relating to the overall weight of the flavoring granulates produced:
aa) 70% to 90% by weight of dry fruit substance
and
bb) a carrier matrix comprising or consisting of
   i) 10% to 30% by weight of a magnesium salt of one or more solid, edible acids
or
   ii) a mixture of
      a. 5% to 15% by weight of magnesium hydroxide and
      b. 5% to 15% by weight of one or more solid, edible acids.

The percentages by weight of the components aa) and bb) relate in each case to the overall weight of the flavoring granulates produced.

The flavoring granulates, according to the invention, as well as the preferred embodiments thereof, have a substantially spherical geometry, which is characterized by a high sphericity.

According to H. Wadell (“Volume, Shape and Roundness of Rock Particles”, Journal of Geology 40, (1932), 443-451) the sphericity corresponds to the ratio of the surface area of a sphere of the same volume to the actual surface area. According to this definition, the sphericity can be accorded numerical values in the range of >0 to 1. According to the invention, preferred flavoring particles have a sphericity of greater than or equal to 0.75, particularly preferably greater than or equal to 0.90.

According to the invention, the flavoring granulates that have essentially spherical geometry have a solid spherical mass. In the sense of the invention, a solid spherical mass means that the interior of the granulates consists of the components fruit dry matter and carrier matrix and does not have a hollow body in the sense of a form with core and skin.

As a result, loading with dry fruit matter in relation to the volume of granulates in accordance with the invention is increased in contrast to particles produced by means of spray drying, since the latter procedure results in the creation of hollow bodies. In addition, by using the fluidized-bed process in accordance with the invention, free-flowing, dust-reduced, granular granulates having a narrow grain size distribution are produced, so that subsequent sieving of the granulates obtained is reduced or no longer required.

In contrast to granulates with a high content of dry fruit matter, which are manufactured by means of the fluidized-bed procedure from the prior art, with the process according to the invention, this does not lead to clumping of the content of the fluidized-bed, so that no granulates with larger dimensions are created.

The spray composition used according to the fluidized-bed process in accordance with the invention, in contrast to the spray composition described in the U.S. Pat. No. 4,664,920, is stable over a longer period of time and particularly also stable with regard to color. Thus, it has been shown that in using the fluidized-bed process according to the invention in the pilot stage the spray composition remains stable over the whole period of the process, especially over a period of 5 hours. With commercial production of flavoring granulates according to the invention, according to the fluidized-bed process in accordance with the present invention, the spray composition remains stable over a period of about 10 hours using about one ton of the mixture.

The flavoring granulates according to the invention generally are of a mean particle size in the range of 250 to 1500 μm, preferably the particle size can be adjusted in the range of 400 μm to 1000 μm, depending on the type and size of the components to be mixed.

Preferably, the flavoring granulates according to the invention are characterized by a bulk density in the range of 600 to 900 g/l.

Preferably, flavoring granulates according to the invention have a particle size distribution as follows:

Residue in a sieve of 1400 μm: 0%
Residue in a sieve of 1200 μm: <10%
Residue in a sieve of 710 μm: >80%
Residue in a sieve of 500 μm: <10%

These particle characteristics of the flavoring granulates in accordance with the invention, as well as their preferred embodiments ensure, for example, that de-mixing of the granulates, for example, tea leaves, is reduced, and/or the escape of the granulates from containers such as, for example, tea bags, is prevented. Consequently, granulates according to the invention can be more readily mixed with products suitable for consumption and/or be packed in containers and/or be stored.

An important area of application for the flavoring granulates according to the invention, as well as their preferred embodiments, is therefore the flavoring of tea in tea bags. Precisely by means of the relatively uniform spherical form as well as by means of the particle characteristics of the granulates according to the invention and their preferred embodiments, de-mixing of the granulates from the tea base and/or escape of the granulates from the tea bag can be prevented.

According to the present invention, the dry fruit matter is manufactured from corresponding fruit juices and/or fruit juice concentrates, although not from fruit pulps or fruit purees. In this way, the dry fruit matter will not contain pieces of skin, seeds or core.

By the term ‘fruit’ within the meaning of the present invention, is meant edible plant products, especially from trees and bushes. The term ‘fruit’ is especially understood to be edible varieties of fruit and/or vegetable products.

Preferred fruit varieties for fruit juices and/or fruit juice concentrates are selected from the group comprising cherries, grapefruit, kiwi fruit, apples, pears, citrus fruits, pineapples, plums, star-fruit, redcurrants, blackcurrants, blackberries, apricots, mangos, pomegranates, aronias, melons, pitaya, cranberries and mandarins. Further preferred are fruit juices and/or fruit juice concentrates selected from the group comprising strawberries, oranges, lemons, raspberries and peaches.

Preferred vegetable varieties for the fruit juices and/or the fruit juice concentrates are selected from the group comprising bulb vegetables, preferably onions and/or leeks; cabbage vegetables, preferably Savoy cabbage, red cabbage, swede and/or cauliflower, asparagus, tomatoes, carrots and peppers. Further preferred vegetables are tomatoes and carrots.

The fruit acids that are used in the fruit juices and/or fruit juice concentrates of fruit or vegetable varieties are not included in the calculation of the component part of the solid, edible acids of the carrier matrix bb).

In the meaning of the present invention, the edible acids are solid at 20° C. and can be employed in the foodstuffs sector. Preferably, the edible acids are polybasic acids. Preferred acids are selected from the group comprising citric acid, tartaric acid, phosphoric acid, maleic acid, adipic acid, succinic acid, malic acid, fumaric acid, ascorbic acid (vitamin C) as well as mixtures of two or more of these acids. Especially preferred are citric acid and mixtures of citric acid and ascorbic acid.

By means of the (high) acid content, during manufacture of the flavoring granulates in accordance with the invention and during subsequent storage, undesirable loss of coloration does not occur, i.e. the flavoring granulates according to the invention are stable in color. Therefore, the original color of the fruit can be maintained in the flavoring granulate. Generally, the pH-value of the spray composition is acidic and preferably has a pH-value between 2.5 and 6.9, more preferably between 4.0 and 5.0.

One or more of the acids, which according to the invention is preferably citric acid, can partly be replaced by ascorbic acid, preferably in the range of 10% to 50% by weight relative to the overall content of the edible acids of the carrier matrix bb). This can also have a health promoting effect on the consumer.

The amount ratios of a. magnesium hydroxide to b. the overall proportion of the solid, edible acids for preferred flavoring granulates, according to the invention, is generally within the range of 3:2 to 2:3, preferably within the range of 1.2:1 to 1:1.2, and more preferably 1:1.

For the preferred amount ratio of magnesium hydroxide to acid 1:1, the following preferred ranges for the molar ratios of magnesium hydroxide to acid result, namely 1.9 to 3.5:1, more preferably 1.99 to 3.30:1, and especially preferred 2.3 to 3.3:1

In particular, the following molar ratios of magnesium to acid result for citric acid, ascorbic acid, malic acid, tartaric acid, succinic acid and fumaric acid for a ratio of 1:1 of magnesium to acid:

| | |
|---|---|
| Citric acid | 3.30:1 |
| Ascorbic acid (Vitamin C) | 3.02:1 |
| Malic acid | 2.30:1 |
| Tartaric acid | 2.57:1 |
| Succinic acid | 2.02:1 |
| Fumaric acid | 1.99:1 |

Preferably, citric acid, ascorbic acid and/or malic acid are used as the edible acid in the carrier matrix bb) in the above-indicated molar ratios. Here again, a portion of citric acid, preferably within the range of 10% to 50% by weight relative to the overall proportion of the edible acids of the carrier matrix bb), can be replaced by ascorbic acid.

Relative to the overall weight of the flavoring granulates, the flavoring granulates, according to the invention, comprise overall less than 6% by weight, preferably less than 3% by weight of one or more carrier materials selected from the group comprising chemically or physically modified starches, modified celluloses, gum Arabic, ghatti gum, tragacanth, karaya, carrageen, guar gum, locust bean gum, alginates, inulin, xanthan gum, dextrins and maltodextrins. Preferably, according to the invention, the flavoring particles are, however, free from the above-mentioned additive carrier materials.

According to the process according to the invention, one or more solvents can optionally be used as the component a) in the spray composition (as a solution, suspension and emulsion in the process step A)), in addition to the fruit juices and/or the fruit concentrates as the component bb). Preferably, these are selected from the group comprising water, ethanol, methanol, propylene glycol, isopropanol and acetone.

The water content of the flavoring granulates according to the invention is generally less than 7% by weight, preferably less than 3% by weight.

These different amounts of residual water in the flavoring granulates according to the invention, as well as their preferred embodiments, result from the viscosity of the spray component, that is to say, the solution, emulsion or suspension of the process step A), which has to be suitable for atomization in the fluidized-bed procedure. The viscosity is dependent upon the type of atomization and usually is within the range of 10 to 1,000 mPas, preferably 75 to 500 mPas, more preferably within the range of 150 to 300 mPas [the latter corresponds to a content of dry matter (fruit dry matter according to the invention as well as carrier material) of about 50% by weight in relation to the wet spray composition], in each case measured with a rotation viscometer at 20° C. at a sheering speed of 2000 s⁻¹. If it is possible to heat the composition until dry, the viscosity at 20° C. can be even higher than that indicated.

Flavoring granulates according to the invention as well as their preferred embodiments having an essentially spherical geometry and a solid spherical mass can, according to the invention, be manufactured by means of a fluidized-bed process, preferably by means of fluidized-bed spray granulation. Especially preferred within the scope of the present invention, is fluidized-bed spray granulation with internal seed formation, as is described, for example, in WO 00/36931 or in U.S. Pat. No. 4,946,654.

The process according to the invention can be carried out in a discontinuous or continuous manner. The process according to the invention is preferably carried out in a continuous manner. A continuous process is better suited for an industrial procedure and has shorter rest periods. With the same material throughput, the bed content with the continuous processes of fluidized-bed spray granulation is less than with the discontinuous processes. Instead of allowing the total amount of all granulate seeds to grow simultaneously, in continuous fluidized-bed spray granulation only a small amount of the granulate seeds is sprayed and, after reaching the desired particle size, it is immediately discharged via a sizer.

A particularly suitable process for fluidized-bed spray granulation and a device for carrying out such a process are, for example, known from U.S. Pat. No. 4,946,654. Normally, such an apparatus comprises a fluidized-bed granulator,
which contains one or more components for spraying the product that is supplied in a sprayable form,
which also contains appropriate systems one or more return ducts of the fine material escaping from the fluidized bed [sic],
   and/or
has one or more counter-flow gravitation sizers attached directly to its inflow floor.

The flavoring granulates according to the invention, as well as their preferred embodiments, having narrow particle size distributions can preferably be manufactured by means of a fluidized-bed process, preferably by fluidized-bed spray granulation, in a manner such that
a) the solution, suspension or emulsion that is to be granulated is sprayed in a liquid state into a fluidized bed,
b) the fine materials that escape with the off-gas from the fluidized bed are separated and returned into the fluidized bed as seeds for granulate formation,
c) just by adjustment of the classifying gas current, the granulation procedure in the fluidized bed is affected in such a way that the flavoring granulates are produced in a size that has been pre-set by the classifying gas flow,
d) the finished granulate is solely removed by means of the one or more counter-flow gravitation sizers that are fitted into the inflow bottom of the fluidized-bed apparatus,
and/or
e) the granulates produced in this way are optionally subjected to thermal after-treatment.

The one or more magnesium salts or magnesium hydroxide in combination with the one or more edible acids can, preferably, be introduced into the spray mixture in the form of a powder.

The fluidized-bed process according to the invention, preferably a fluidized-bed spray granulation process, for producing granulates in accordance with the invention, as well as their preferred embodiments, can preferably be carried out in such a manner that by means of the classifying gas supply the granulate formation procedure, that is to say, the change between granulate growth and seed formation, is automatically set to a pre-determined size of the discharged granulates according to the invention. Such a preferred procedure for carrying out the process of the present invention is described, for example, in EP 0 332 031 and EP 0 332 929.

In principle, however, the fluidized-bed process according to the invention can also be carried out by means of standard granulators in a continuous or batch-wise manner.

The sifting can also be carried out separately and/or subsequently with sieves or other sizers.

Seed material that is required to build granulates in the fluidized bed, can, as a rule, be produced by milling or, as already described above, can be separated from the fluidized bed as fine material in the off-gas and then returned to the fluidized bed for formation of the granulates.

As a rule, the gas inflow temperature does not exceed 160° C. and preferably lies within the range of 40° C. to 140° C. and more preferably within the range of 80° C. to 120° C.

The off-gas temperature in the fluidized-bed process according to the invention does not exceed 85° C. and preferably lies within the range of 40° C. to 80° C. and more preferably within the range of 65° C. to 75° C.

A product that is suitable for consumption, preferably a foodstuff and/or luxury food, is a product that is intended to enter the human mouth, there to remain for a specific period of time and subsequently to be either swallowed, i.e. digested (e.g. a foodstuff) or removed from the mouth (e.g. chewing gum). Included here are also all substances or products which are intended, in their finished, semi-finished or unfinished state to be ingested by humans. Included here are all substances that are added to foodstuffs during their manufacture, modification or treatment.

Chewing gums generally comprise a chewing gum base, i.e. a chewing mass that becomes soft when chewed, sugars of various types, sugar replacement products, sweeteners, hexose alcohols, moistening agents, thickeners, emulsifying agents, flavorings and/or other stabilizers.

Preferred products suitable for consumption are selected from the group comprising bakery products (biscuits, cakes, muffins, waffles, baking mixtures), sugar products (hard toffees, soft toffees, chewy sweets, pastilles), dairy products (yoghurts, puddings, ice cream), chocolate products (white, milk or dark chocolate, chocolate bars), fat-containing fillings (bakery fillings such as, for example, biscuit fillings, chocolate fat-fillings, chocolate bar fat-fillings), chewing gums (sugar-free, sugar-containing), cereals (oat flakes, corn flakes), muesli mixtures (traditional loose muesli, student snacks), muesli bars, snacks and snack mixtures (sweet popcorn, mixtures of fruit pieces, nuts, nut bars, fruit and nut bars), powder products (instant desserts in powder form such as instant puddings or trifles) and toppings.

The proportion of flavoring granulates as well as their preferred embodiments used in a product according to the invention (suitable for consumption) depending on the product type, is generally within the range of 0.1% to 20% by weight, preferably within the range of 0.25% to 10% by weight, in each case in relation to the overall weight of the product.

Additional common basic, auxiliary and additive substances used in foodstuffs or luxury foods can generally be included in amounts of 0.00001% to 99.9% by weight, preferably 10% to 80% by weight in relation to the overall weight of the preparation. Furthermore, the preparations can contain water in amounts up to 99.9% by weight, preferably 5% to 80% by weight in relation to the overall weight of the preparation.

The products that are suitable for consumption in the sense of the invention can also be in the form of semi-finished products for the production of further preparations for nutrition or enjoyment. Products in the sense of the invention can also be in the form of capsules, tablets (non-coated as well as coated tablets such as, for example, gastric juice-resistant coatings), pills, granulates, pellets, mixtures of solids, dispersions in liquid phases, as emulsions, powders, solutions, pastes or other swallowable or chewable preparations as nutritional supplements.

The proportion of the flavoring granulates, according to the invention, present in a semi-finished product according to the invention, depending on the product type, generally is within the range of 0.1% to 20% by weight, preferably within the range of 0.25% to 10% by weight, in each case relating to the overall weight of the product.

As further components of the preparations according to the invention serving nutritional or luxury purposes, further, known basic, auxiliary and additive substances can be used such as, for example, water, mixtures of fresh or processed basic or raw material of plant or animal origin, digestible or non-digestible carbohydrates (for example, saccharin, maltose, fructose, glucose, dextrin, amylose, amylopectin, inulin, xylan, cellulose), hexose alcohols (for example, sorbitol, mannitol, xylitol), natural or hardened fats (for example, tallow, lard, palm oil, coconut oil, hardened plant oils), fatty oils (for example, sunflower oil, groundnut oil, maize-seed oil, thistle oil, olive oil, walnut oil, fish oil, soya oil, sesame oil), fatty acids or their salts (for example, potassium stearate, potassium palmitate), proteinogenic or non-proteinogenic amino acids and related compounds (for example, taurine, creatine, creatinine), peptides, native or processed proteins (for example, gelatins), enzymes (for example, peptidases, glycosidase, lipases), nucleic acids, nucleotides (inositol phosphate), taste-modulating substances (for example, sodium glutamate, 2-phenoxy-propionic acid), emulsifying agents (for example, lecithins, diacyl-glycerols), stabilizers (for example, carrageen, alginate, locust bean gum, guar gum), preservatives (for example, benzoic acid, sorbic acid), antioxidants (for example, tocopherol, ascorbic acid), chelating agents (for example, citric acid), organic or inorganic acidifying agents (for example, malic acid, acetic acid, citric acid, tartaric acid, phosphoric acid), bitter substances (for example, quinine, caffeine, limonene), sweeteners (for example, saccharin, cyclamate, aspartame, neotame, neohesperidine dihydrochalcone), mineral salts (for example, sodium chloride, potassium chloride, magnesium chloride, sodium phosphates), enzymatic browning inhibiters (for example, sulfite, ascorbic acid), ethereal oils, plant extracts, natural or synthetic coloring agents or color pigments (for example, carotinoids, flavonoids, anthocyanes, chlorophyll and its derivatives), spices as well as odoriferous substances, synthetic, natural or identical to nature flavoring substances and taste-promoting substances.

In the sense of the present invention, semi-finished products can be used for flavoring products finished therefrom as finished products.

The following examples illustrate the invention without restricting the invention solely to the embodiments. Insofar as there are no indications to the contrary, all data used refers to the weight.

Flavoring particles according to the invention were manufactured from the following compositions A) to C) by means of fluidized-bed spray granulation with internal seed formation, with reference to the processes disclosed in WO 00/36931 or U.S. Pat. No. 4,946,654.

### Production Processes

A mixture A), B) or C) (see below) is granulated in a granulating apparatus of the type described in EP 163 836 (with the following characteristics: Diameter of the inflow floor: 225 mm; Spray nozzle: double nozzle; Sieving discharge: Zigzag classifier; Filter: Internal tube filter). The mixture is sprayed at a temperature of 32° C. into the fluidized-bed granulator. Fluidization of the bed content is done by blowing in nitrogen at a rate of 70 kg/h. The inflow temperature of the fluidization gas is 140° C. The temperature of the discharge gas is 76° C. Nitrogen is also fed through as the classifying gas at a rate of 5 kg/h with a temperature of 50° C. A free-flowing granulate is obtained with a mean particle diameter of 0.9 mm at a bulk density of 600 g/l to 900 g/l. The granulates are substantially round and have a substantially smooth surface. Stationary conditions with regard to the granulation process are to be assumed owing to the constant loss of pressure of the filter and the likewise persistently constant bed content.

The distribution of particle sizes according to the present process examples is measured with a Malvern laser measuring instrument or by means of a Retsch sieve tower.

The bulk density in the present process examples is determined by means of a 100 ml upright measuring cylinder.

The sphericity for at least 20 individual particles of the flavoring granulates according to the invention for the present invention and the present process examples is measured with the aid of an incident light stereo microscope with built-in measuring scale.

### A) Composition for Raspberry Flavoring Granulates

| Raspberry concentrate, clear, 65 °Brix | 1200 gm |
|---|---|
| Magnesium hydroxide | 100 gm |
| Citric acid | 100 gm |
| Water | 600 gm |
| Bulk density | 890 g/l |
| Residual moisture | 2.4% |
| Fruit - dry matter | 79.2% |

The term ° Brix (“Degrees Brix”) defines the dry matter content of the juice concentrate used.

### B) Composition for Orange Flavoring Granulates

| Orange juice concentrate, 65 °Brix | 1200 gm |
|---|---|
| Magnesium hydroxide | 100 gm |
| Citric acid | 100 gm |
| Water | 350 gm |
| Bulk density | 695 g/l |
| Residual moisture | 1.26% |
| Fruit - dry matter | 79.2% |

### C) Composition for Cherry Flavoring Granulate

| (Sour)Cherry juice concentrate, 56 °Brix | 3800 gm |
|---|---|
| Magnesium hydroxide | 353 gm |
| Citric acid | 353 gm |
| Bulk density | 710 gm/l |
| Residual moisture | 3.3% |
| Fruit - dry matter | 71.3% |

For the particle density of all products the following applies:

| | |
|---|---|
| Residue on sieve | 1400 μm: 0% |
| Residue on sieve | 1200 μm: <10% |
| Residue on sieve | 710 μm: >80% |
| Residue on sieve | 500 μm: <10 |

### EXAMPLE F1

### Chewing Gum Containing Flavoring Granulates According to the Invention

| | | |
|---|---|---|
| Water | | 7.7% |
| Sugar | Refined sugar C4 | 41.0% |
| Glucose Syrup | Dextrose 40 | 37.3% |
| Hardened Plant Oil | Melting point | 6.5% |
| | 32-36° C. | |
| Lecithin | Emulsifier (soya | 0.3% |
| | lecithin) | |
| Gelatin | Pork gelatin | 0.8% |
| Fondant | Type S30 | 4.8% |
| Flavoring granulates from | | 1.6% |
| Example A) | | |

### EXAMPLE F2

### Tablet Containing Flavoring Granulates According to the Invention

| | | |
|---|---|---|
| Dextrose | | 97.1% |
| Magnesium stearate | Slip agent | 0.9% |
| Citric acid | | 0.2% |
| Flavoring granulates from | | 1.8% |
| Example A) | | |

### EXAMPLE F3

### Fruity Muesli Bar containing Flavoring Granulates According to the Invention

| | | |
|---|---|---|
| Saccharose | Sugar | 16.0% |
| Glucose syrup | | 14.0% |
| Sorbitol P 300 | Humidifying | 5.0% |
| | agent | |
| Plant oil | | 5.0% |
| Water | | 3.0% |
| Rolled Oats | | 13.3% |
| Oat Flakes | Oat extrudates | 10.0% |
| Corn flakes | | 5.5% |
| Rice crispies | Rice extrudates | 20.0% |
| Currents | | 5.0% |
| Flavoring granulates from | | 1.0% |
| Example C) | | |
| Flavoring granulates from | | 2.0% |
| Example B) | | |
| Powdered Citric acid | | 0.2% |

### EXAMPLE F4

### Tea Containing Flavoring Granulates According to the Invention

800 gm of Rooibos tea or Black tea fannings are placed in a 5 liter Lodige ploughshare mixer. The tea leaves are pre-mixed and fluidized. Without interrupting the mixing process, 5 gm of a fine neutral oil mist (MCT Oil Aerosol) are sprayed onto the fluidized tea leaves via a single or two-component nozzle. This takes about 60 seconds. Without interrupting the mixing process, 33 gm of the above-mentioned orange flavoring granulate (Example B)) are added to the mixture, optionally with the addition of 5 gm of neutral oil (MCT Oil/medium chain triglyceride oil) and the total mixture is mixed for a further 60 seconds.

### EXAMPLE F5

### Sugar-free Chewing Gum containing Flavoring Granulates According to the Invention

| | | % by |
|---|---|---|
| Part | Component Material | weight |
| A | Chewing gum base, from the ‘Jagum T’ | 30.00 |
| | Company | |
| B | Sorbitol, powdered | 39.00 |
| | Isomalt ® (Palatinit GmbH) | 9.50 |
| | Xylitol | 2.00 |
| | Mannitol | 3.00 |
| | Aspartame ® | 0.10 |
| | Acesulfame ® K | 0.10 |
| | Emulgum ® (Colloides Naturels Inc.) | 0.30 |
| C | Sorbitol, 70% | 13.50 |
| | Glycerin | 1.00 |
| D | Menthol-Eucalyptus Flavoring | 1.00 |
| | Flavoring granulates from Example B) | 0.50 |

### EXAMPLE F6

### Chewing Gum containing Flavoring Granulates According to the Invention

The chewing gum base K2 consisted of the following components: 28.5% by weight of terpene resin, 33.9% by weight of polyvinyl acetate (MW=14,000), 16.25% by weight of hydrated plant oil, 5.5% by weight of mono- and diglycerides, 0.5% by weight of poly-isobutene (MW=75,000), 2.0% by weight of butyl rubber (isobutene-isoprene-co-polymer), 4.6% by weight of amorphous silicon dioxide (water content ca. 2.5%), 0.05% by weight of antioxidant tert.-butyl-hydroxy-toluene (BHT), 0.2% by weight of lecithin and 8.5% by weight of calcium carbonate. The production of the chewing gum base K2 and of the chewing gum was carried out in a manner analogous to that disclosed in U.S. Pat. No. 6,986,907.

| | I. % by | II. % by | III. % by |
|---|---|---|---|
| | weight | weight | weight |
| Chewing gum base K2 | 25.30 | 27.50 | 26.30 |
| Sorbitol | 61.48 | 59.68 | 61.80 |
| Glycerin | 2.40 | 2.40 | 2.40 |
| Lecithin | 7.00 | 7.00 | 7.00 |
| Aspartame | 0.14 | 0.14 | 0.14 |
| Encapsulated aspartame | 0.68 | 0.68 | 0.68 |
| Menthol, spray-dried | 0.50 | — | 0.50 |
| Cherry flavoring, | — | 1.20 | — |
| spray-dried | | | |
| Flavoring granulates from | 1.50 | 1.40 | — |
| Example B) | | | |
| Flavoring granulates from | 1.00 | — | 1.18 |
| Example C) | | | |

### Further Embodiments

A first embodiment is a fluidized-bed process for the manufacture of flavoring granulates, wherein the process comprises the following stages or consists thereof:
A) Preparation of a solution, emulsion or suspension comprising or consisting of
   a) optionally one or more solvents
   and
   b) a mixture comprising or consisting of
   aa) fruit juice and/or fruit juice concentrate
   and
   bb) a carrier matrix comprising or consisting of
      i) a magnesium salt of one or more solid, edible acids
      or
      ii) a mixture of
         a. magnesium hydroxide and
         b. one or more solid, edible acids,
B) Spraying the solution, emulsion or suspension from A) into a fluidized-bed granulator, and
C) Separation of the flavoring granulates obtained, which substantially have a spherical geometry with solid spherical bodies, comprising or consisting of the following components, in each case relating to the overall weight of the flavoring granulates obtained:
   aa) 60% to 90% by weight of dry fruit substance
   and
   bb) a carrier matrix comprising or consisting of
      i) 10% to 40% by weight of a magnesium salt of one or more solid, edible acids
      or
      ii) a mixture of
         a. 5% to 20% of magnesium hydroxide and
         b. 5% to 20% of one or more solid, edible salts.

A second embodiment is the fluidized-bed process of the first embodiment, wherein the gas inflow temperature is within the range of 40° C. to 140° C. and the off-gas temperature is within the range of 40° C. to 80° C.

A third embodiment is the fluidized-bed process of the first or second embodiment, wherein the amount ratios of a. magnesium hydroxide to b. the overall proportion of solid, edible acids are within the range of 3:2 to 2:3, preferably of 1.2:1 to 1:1.2 and more preferably 1:1.

A fourth embodiment is the fluidized-bed process of the third embodiment, wherein the amount ratio of a. magnesium hydroxide to b. the overall proportion of solid, edible acids is 1:1 and the molar ratios are within the range of 1.9 to 3.5:1, preferably within the range of 1.99 to 3.3:1 and more preferably within the range of 2.3 to 3.3:1.

A fifth embodiment is flavoring granulates that can be manufactured as described in any one of the first four embodiments, wherein the flavoring granulates have a substantially spherical geometry with a solid spherical body, comprising or consisting of the following components, in each case relating to the overall weight of the flavoring granulates produced:
aa) 60% to 90% by weight of dry fruit substance
and
bb) a carrier matrix comprising or consisting of
   i) 10% to 40% by weight of a magnesium salt of one or more solid, edible acids
or
   ii) a mixture of
      a. 5% to 20% by weight of magnesium hydroxide and
      b. 5% to 20% by weight of one or more solid, edible acids.

A sixth embodiment is flavoring granulates as described in the fifth embodiment, wherein the flavoring granulates comprise or consist of the following components:
aa) 70% to 90% by weight of dry fruit substance
and
bb) a carrier matrix comprising or consisting of
   i) 10% to 30% by weight of a magnesium salt of one or more solid, edible acids,
or
   ii) a mixture of
      a. 5% to 15% by weight of magnesium hydroxide and
      b. 5% to 15% by weight of one or more solid, edible acids.

A seventh embodiment is flavoring granulates as described in the fifth or sixth embodiments, wherein the amount ratios of a. magnesium hydroxide to b. the overall proportion of solid, edible acids are within the range of 3:2 to 2:3, preferably of 1.2:1 to 1:1.2 and more preferably 1:1.

An eighth embodiment is flavoring granulates as described in the seventh embodiment, wherein the amount ratio a. magnesium hydroxide to b. the overall proportion of solid, edible acids is 1:1, and the molar ratios are within the range of 1.9 to 3.5:1, preferably within the range of 1.99 to 3.3:1, and more preferably within the range of 2.3 to 3.3:1.

A ninth embodiment is flavoring granulates as described in any one of the fifth through eight embodiments, wherein the flavoring granulates have a mean particle size within the range of 400 μm to 1000 μm.

A tenth embodiment is flavoring granulates as described in any one of the fifth through ninth embodiments, wherein the flavoring granulates have a bulk density within the range of 600 to 900 g/l.

An eleventh embodiment is flavoring granulates as described in any one of the fifth through tenth embodiments, wherein the flavoring granulates have a particle size distribution as follows:

Residue on the sieve 1400 μm: 0%
Residue on the sieve 1200 μm: <10%
Residue on the sieve 710 μm: >80%
Residue on the sieve 500 μm: <10%.

A twelfth embodiment is an edible product comprising flavoring granulates as described in any one of the fifth through eleventh embodiments.

A thirteenth embodiment is the product as described in the twelfth embodiment, wherein the product is selected from the group comprising foodstuffs, luxury foods and semi-finished products.

A fourteenth embodiment is the use of flavoring granulates as described in any one of the fifth through eleventh embodiments, in foodstuffs, luxury foods and semi-finished products.

A fifteenth embodiment is the use of flavoring granulates as described in any one of the fifth through eleventh embodiments, for the manufacture of foodstuffs, luxury foods and semi-finished products.

1. A fluidized-bed process for the manufacture of flavoring granulates, comprising:
A) preparing a solution, emulsion, or suspension comprising:
a) a mixture comprising:
aa) fruit juice and/or fruit juice concentrate;
and
bb) a carrier matrix comprising
i) a magnesium salt of one or more solid, edible acids; or
ii) a mixture of:
a. magnesium hydroxide; and
b. one or more solid, edible acids; and optionally
b) one or more solvents;
B) spraying the solution, emulsion, or suspension of A) into a fluidized-bed granulator to obtain flavoring granulates; and
C) separating flavoring granulates obtained in B), which substantially have a spherical geometry with solid spherical bodies, and comprise the following components, in each case relating to the overall weight of the flavoring granulates obtained:
aa) 60% to 90% by weight of dry fruit substance; and
bb) a carrier matrix comprising
i) 10% to 40% by weight of a magnesium salt of one or more solid, edible acids;
or
ii) a mixture of:
a. 5% to 20% of magnesium hydroxide; and
b. 5% to 20% of one or more solid, edible salts.

2. The process of claim 1, wherein said fluidized-bed granulator has a gas inflow temperature within the range of from 40° C. to 140° C. and an off-gas temperature within the range of from 40° C. to 80° C.

3. The process of claim 1, wherein the ratio of the amount of magnesium hydroxide to the overall proportion of solid, edible acids in a) is within the range from of 2:3 to 3:2.

4. The process of claim 3, wherein the ratio of the amount of magnesium hydroxide to the overall proportion of solid, edible acids in a) is 1:1 and the molar ratio of MgOH₂ to the overall proportion of solid, edible acids is within the range of from 1.9 to 3.5:1.

5. Flavoring granulates comprising:
aa) 60% to 90% by weight of dry fruit substance;
and
bb) a carrier matrix comprising:
i) 10% to 40% by weight of a magnesium salt of one or more solid, edible acids;
or
ii) a mixture of
a. 5% to 20% by weight of magnesium hydroxide; and
b. 5% to 20% by weight of one or more solid, edible acids;
in each case relating to the overall weight of the flavoring granulates produced;
wherein the flavoring granulates have a substantially spherical geometry with a solid spherical body.

6. The flavoring granulates of claim 5, comprising;
aa) 70% to 90% by weight of dry fruit substance;
and
bb) a carrier matrix comprising:
i) 10% to 30% by weight of a magnesium salt of one or more solid, edible acids;
or
ii) a mixture of
a. 5% to 15% by weight of magnesium hydroxide; and
b. 5% to 15% by weight of one or more solid, edible acids.

7. The flavoring granulates of claim 5, wherein the ratio of the amount of magnesium hydroxide to the overall proportion of solid, edible acids in a) is within the range of 2:3 to 3:2.

8. The flavoring granulates of claim 7, wherein the ratio of the amount of magnesium hydroxide to the overall proportion of solid, edible acids in a) is 1:1, and the molar ratio of MgOH₂ to the overall proportion of solid, edible acids is within the range of from 1.9 to 3.5:1.

9. The flavoring granulates of claim 5, wherein said flavoring granulates have a mean particle size within the range of from 400 μm to 1000 μm.

10. The flavoring granulates of claim 5, wherein said flavoring granulates have a bulk density within the range of from 600 to 900 g/l.

11. The flavoring granulates of claim 5, wherein said flavoring granulates have a particle size distribution as follows:
Residue on a 1400 μm sieve: 0%
Residue on a 1200 μm sieve: <10%
Residue on a 710 μm sieve: >80%
Residue on a 500 μm sieve: <10%.

12. An edible product comprising flavoring granulates comprising the following components:
aa) 60% to 90% by weight of dry fruit substance;
and
bb) a carrier matrix comprising:
i) 10% to 40% by weight of a magnesium salt of one or more solid, edible acids;
or
ii) a mixture of
a. 5% to 20% by weight of magnesium hydroxide; and
b. 5% to 20% by weight of one or more solid, edible acids;
in each case relating to the overall weight of the flavoring granulates produced;
wherein the flavoring granulates have a substantially spherical geometry with a solid spherical body.

13. The product of claim 12, wherein said product is selected from the group consisting of foodstuffs, luxury foods, and semi-finished products.
